(19) United States
(12) Patent Application Publication
(10) Pub. No.: US 2004/0220952 A1
(43) Pub. Date: Nov. 4, 2004

(54) Web service gateway generation

(75) Inventor: Manoj Cheenath, Alameda, CA (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 10/860,079

(22) Filed: Jun. 3, 2004

Related U.S. Application Data
(63) Continuation of application No. 10/337,755, filed on Jan. 7, 2003.
(60) Provisional application No. 60/406,798, filed on Aug. 29, 2002.

(51) Int. Cl. G06F 7/00

(52) U.S. Cl. 707/100

(57) ABSTRACT

Providing a web service gateway to multiple remote web services where the remote web services may span heterogenous hardware and software platforms. The web service gateway receives an invoke call for a target web service and invokes the target web service with a second invoke call. Web services are accessed using standard web protocols such as XML and HTTP. The application that provides the functionality is packaged as a web service allowing each system to communicate with any other system. The web service gateway is implemented in java using java communication commands and java programming objects.

### CROSS REFERENCE TO RELATED APPLICATIONS

The present application is related to the following U.S. patents and patent applications, which patents/applications are assigned to the owner of the present invention, and which patents/applications are incorporated by reference herein in their entirety:

U.S. patent application entitled “SYSTEM FOR RUNTIME WEBSERVICE TO JAVA TRANSLATION”, patent application Ser. No. 10/337,352, filed on Jan. 7, 2003 currently pending, which claims benefit to provisional patent application entitled “SYSTEM FOR RUNTIME WEB SERVICE TO JAVA TRANSLATION”, Application No. 60/406,786, filed on Aug. 29, 2002; and

U.S. patent application entitled “SYSTEM FOR WEBSERVICE GENERATION AND BROKERING”, patent application Ser. No. 10/337,755, filed on Jan. 7, 2003 currently pending, which claims benefit to provisional patent application entitled “SYSTEM FOR WEBSERVICE GENERATION AND BROKERING”, Application No. 60/406,798, filed on Aug. 29, 2002;

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to the field of web services, and more particularly to generating a web services gateway.

### BACKGROUND OF THE INVENTION

Web services are a type of service shared by and used as components of distributed web-based applications. They commonly interface with existing back-end applications, such as customer relationship management systems, order-processing systems, and so on. Traditionally, software application architecture tended to fall into two categories: huge monolithic systems running on mainframes or client-server applications running on desktops. Although these architectures work well for the purpose of the applications they were built to address, they are relatively closed to the outside world and can not be easily accessed by the diverse users of the web.

The software industry is now evolving toward loosely coupled service-oriented applications that dynamically interact over the Web. The applications break down the larger software system into smaller modular components, or shared services. These services can reside on different computers and can be implemented by vastly different technologies, but they are packaged and transported using standard Web protocols, such as XML and HTTP, thus making them easily accessible by any user on the Web.

However, applications based on these service-oriented technologies require them to be written using a particular technology, often from a particular vendor. This requirement typically hinders widespread acceptance of an application on the web. For applications written using a different technology or existing on different platforms, extra code must be provided to achieve compatibility between applications. The extra code, accompanied by the required code compiling, consumes valuable programmer time and resources. Further, with smaller modular services it is often the case where multiple web services are needed to complete a task or objective. This requires even more work and code generation by a user. What is needed is a more efficient method of generating and implementing a web service gateway. The web service gateway system should be capable of invoking web services that span diverse hardware and software platforms.

### SUMMARY OF THE INVENTION

The present invention provides a system for generating a web service gateway. The generated web service gateway may invoke multiple remote web services. The remote web services may span diverse hardware and software platforms. A web service gateway may be implemented by receiving an invoke call for a target web service followed by invoking the target web service with a second invoke call. The target web service may be one of a plurality of web services. The first invoke call received from a client on a first platform and the second invoke call is made to the target on a second platform. In one embodiment of the present invention, web services are accessed using standard web protocols such as XML and HTTP. The application that provides the functionality is packaged as a web service allowing each system to communicate with any other system. In one embodiment of the present invention, the invention is implemented in java using java communication commands and java programming objects.

### BRIEF DESCRIPTION OF THE DRAWINGS

FIG. 1 is a diagram of a system for generating a web service in accordance with one embodiment of the present invention.

FIG. 2 is a flow chart showing a method for generating a web service from multiple existing web services in accordance with one embodiment of the present invention.

FIG. 3 is an illustration of a user interface used for generating a web service in accordance with one embodiment of the present invention.

FIG. 4 is a flow chart showing a method for automatically generating a SOAP envelope in accordance with one embodiment of the present invention.

### DETAILED DESCRIPTION

The present invention provides a system for generating web service from multiple remote web services. The remote web services may span heterogenous hardware and software platforms. The web services are each characterized as a java interface and used as normal java object types. In one embodiment of the present invention, web services are accessed using standard web protocols such as XML and HTTP. The application that provides the functionality is packaged as a web service allowing each system to communicate with any other system. In one embodiment of the present invention, the invention is implemented in java using java communication commands and java programming objects.

In one embodiment, web services are hosted by a server, are implemented using standard J2EE components such as Enterprise Java Beans and JMS, and are packaged as standard J2EE Enterprise Applications. A standardized way to transmit data and web service invocation calls between the web service and the user of the web service is implemented using Simple Object Access Protocol (SOAP) as the message format and HTTP as the connection protocol. The standard for describing the web service to clients is implemented as Web Services Description Language (WSDL).

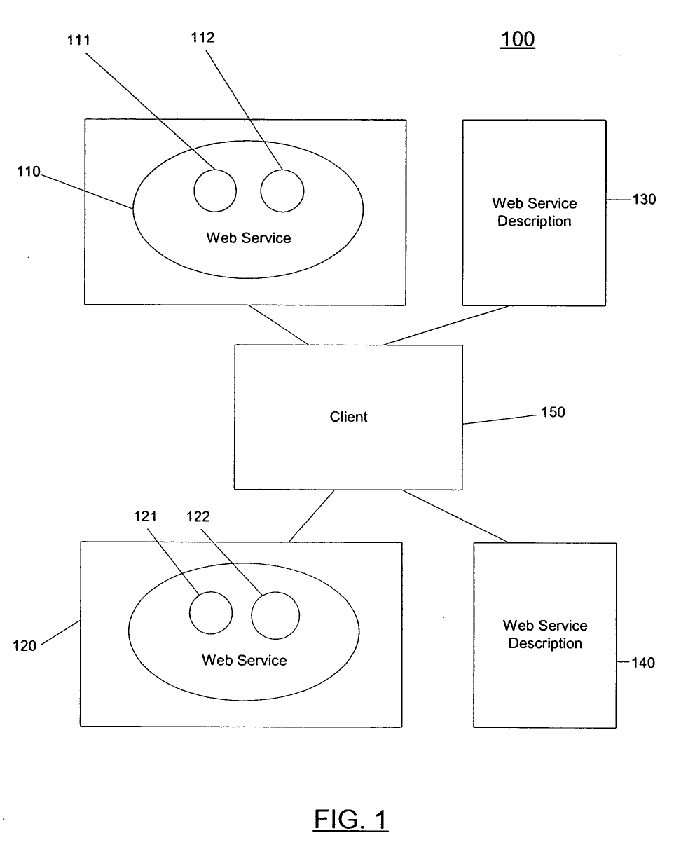

FIG. 1 shows a diagram of a web service invoking system 100 in accordance with one embodiment of the present invention. System 100 includes a first web service 110, a second web service 120, a first web service description file 130, a second web service description file 140, and a client 150. The first web service 110 includes methods 111 and 112. The second web service includes methods 121 and 122. In one embodiment, the methods 111, 112, 121, and 122 are methods implemented in java. Each web service is shown with two methods for discussion purposes only. Web services 110 and 120 could each have more or less than two methods. In one embodiment, the first web service 110 is described by the first web service description file 130 and the second web service 120 is described the second web service description file 140. The client may communicate with the first and second web services and the first and second web service description files. The web services may be located on the same server, on different server instances located on the same machine, or on different machines. The client may be an application running on a server, a remote computer, or any other type of system that may need to invoke a remote web service. In one embodiment, the client has a processor 151 and is able to write and read from a memory 152.

In one embodiment, the web service description files 130 and 140 are WSDL files. WSDL is an XML based specification or format that describes a web service by describing the methods provided by a web service, input and output parameters of the service, and how to use the service. In one embodiment of the present invention, the web service invoking system automatically provides the WSDL file for a web service. In FIG. 1, the web service description file 130 describes corresponding web service 110 and web service description file 140 describes corresponding web service 120.

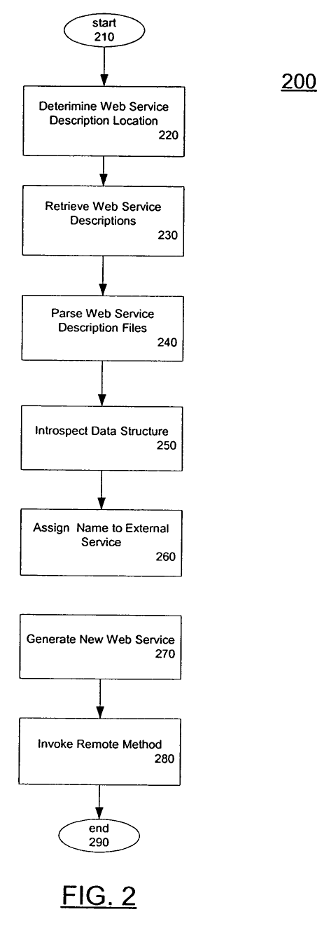

A method 200 for generating a web service in accordance with one embodiment of the present invention is shown in FIG. 2. The method begins with start operation 210. Next, the location of at least two web service description files is provided in operation 220. In one embodiment, each web service description file is a WSDL file. Each WSDL file may be located at a URL address or at some other location. In one embodiment, a URL of a WSDL file is provided by a user or some other means. After the web service description location is provided for each web service description file, each web service description is retrieved by the client in operation 230. In one embodiment of the present invention, the client generates a URL connection with the server. The URL connection may be implemented in java language using java.net.URLConnection( ) or in some other manner. Once the client has connected to the server, the client retrieves the document from the server. In one embodiment, the client retrieves the document by generating an input stream flowing from the server to the client. In one embodiment, the input stream is implemented in java using java.io.InputStream or by some other means. The WSDL file is then retrieved by the client through the input stream created by the java input stream command. The retrieval is performed for each WSDL file used to generate the new web service. An example of a WSDL file in accordance with one embodiment of the present invention is shown below:

```
<?xml version=“1.0”?>
<definitions name=“StockQuote”
targetNamespace=“http://example.com/stockquote.wsdl”
        xmlns:tns=“http://example.com/stockquote.wsdl”
        xmlns:xsd1=“http://example.com/stockquote.xsd”
        xmlns:soap=“http://schemas.xmlsoap.org/wsdl/soap/”
        xmlns=“http://schemas.xmlsoap.org/wsdl/”>
    <types>
      <schema targetNamespace=“http: //example.com/stockquote.xsd”
          xmlns=“http://www.w3.org/2000/10/XMLSchema”>
        <element name=“TradePriceRequest”>
            <complexType>
                <all>
                    <element name=“tickerSymbol” type=“string”/>
                </all>
            </complexType>
        </element>
        <element name=“TradePrice”>
            <complexType>
                <all>
                    <element name=“price” type=“float”/>
                </all>
            </complexType>
        </element>
      </schema>
    </types>
    <message name=“GetLastTradePriceInput”>
        <part name=“body” element=“xsd1:TradePriceRequest”/>
    </message>
    <message name=“GetLastTradePriceOutput”>
        <part name=“body” element=“xsd1:TradePrice”/>
    </message>
    <portType name=“StockQuotePortType”>
        <operation name=“GetLastTradePrice”>
            <input message=“tns:GetLastTradePriceInput”/>
            <output message=“tns:GetLastTradePriceOutput”/>
        </operation>
    </portType>
    <binding name=“StockQuoteSoapBinding”
    type=“tns:StockQuotePortType”>
        <soap:binding style=“document”
transport=“http://schemas.xmlsoap.org/soap/http”/>
        <operation name=“GetLastTradePrice”>
            <soap:operation soapAction=
            “http://example.com/GetLastTradePrice”/>
            <input>
                <soap:body use=“literal”/>
            </input>
            <output>
                <soap:body use=“literal”/>
            </output>
        </operation>
    </binding>
    <service name=“StockQuoteService”>
        <documentation>My first service</documentation>
        <port name=“StockQuotePort”
        binding=“tns:StockQuoteBinding”>
            <soap:address location=“http://example.com/stockquote”/>
        </port>
    </service>
</definitions>
```

Once the WSDL files are retrieved in step 230, each web service description file or WSDL file is parsed in step 240. In one embodiment, a WSDL file is parsed by a java implemented parsing tool at runtime. The parsing tool acts as a pull-XML parser application program interface (API) to parse the WSDL input stream for WSDL messages and place the messages in memory. In one embodiment, the parsed WSDL file messages are placed into an internal data structure in memory. The internal data structure is a java representation of the WSDL file stored in memory. An example of a pseudo representation of the internal data structure in accordance with one embodiment of the present invention is shown below.

[class Definition{
String name;
String targetNamespace;
Message [] messages;
PortType [] portTypes;
Binding [] bindings;
Service [] services;
}
class Message{
String name;
Part [] parts;
}
class Part{
String name;
String namespace;
Class javaType;
}
class PortType{
String name;
Operation [] operations;
}
class Operation{
String name;
Input input;
Output output;
Fault [] faults;
}
class Input{
String message;
}
class Output{
String message;
}
class Fault{
String message;
}
class Binding{
String name;
String type;
BindingOperation [] operations;
}
class BindingOperation{
String name;
String soapAction;
String targetNS;
String encodingStyle;
}
class Service{
String name;
Port [] ports;
}
class Port{
String name;
String binding;
String location;
}

After parsing the WSDL file into an internal data structure, the internal data structure is introspected in step 250 to generate a java interface. In one embodiment, introspecting is performed by a java API with a run-time table. The introspecting java API operates in a manner similar to java reflection APIs. In one embodiment, the java API lists the methods supported by the particular WSDL service and finds the number and type of parameters and return type for each method. The parsed messages are then mapped to java methods. The information may also be manipulated for purposes such as showing all the methods supported by a web service and finding a particular method of a web service. The java methods corresponding to the parsed messages may already be in the memory of the client or retrieved by the client after parsing. In one embodiment, the java interface contains all the methods supported by a particular web service description file and the appropriate signature file. For example, a web service named “ServiceOne” may be located at http://www.services.com. The corresponding java interface generated from the web service description file will be www.services.com.ServiceOne.

After generating a java interface, a name is assigned to each external web service in step 260. In one embodiment, each web service is treated as a member variable. For example, a web service may be given the name serviceone. Thus, the new web service may have a member variable called serviceone with the type www.services.com.ServiceOne. The name assigned to each external web service may be provided by a user or by some other means.

The new web service is generated in step 270. In one embodiment of the present invention, a proxy is created when the new web service is initiated. The proxy implements the java interface generated in step 250. The proxy is also assigned to the member variable. For example, the proxy may implement the java interface www.services.com.ServiceOne and be assigned to member variable ServiceOne. In one embodiment of the present invention, the new web service is stored on the client. The new web service may also be stored on the server that the client resides on, wherein the new web service is accessible from the client. In any case, web service generation occurs when the client creates an Enterprise Java Bean (EJB) having parameters of the member variable type. The EJB is installed on the client such that the client can invoke the EJB as a web service. After the new web service is generated in step 270, a method call may be made on the data member created by the web service generation system. The method call will result in a remote method invocation as shown in step 280. In one embodiment, information required to invoke a remote web service is packaged into a SOAP envelope and may include a target URL, name of the method to invoke, and type and value of the parameters. The required information may be encoded as XML or in some other format suitable for processing over a network such as the Internet. Method 200 then ends in step 290.

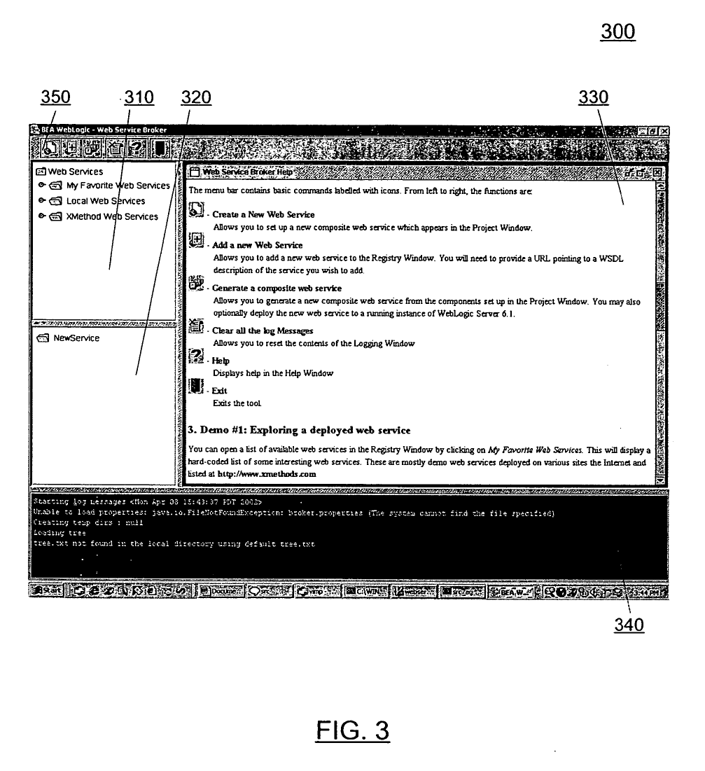

A user interface for generating a web service in accordance with the present invention may take several forms. A user interface 300 for a web service generation and brokering system in accordance with one embodiment of the present invention is illustrated in FIG. 3. User interface 300 includes registry window 310, project window 320, help window 330, console window 340, and menu bar 350. The registry window 310 includes a hierarchy of web services available to the user for generating a new web service. The project window 320 may display components of a website the user is generating. The help window 330 may display instructions and links for using the user interface. The console window 340 may display progress, error, and other messages regarding operation of the system and interface. The menu bar 350 may include icons for performing operations and functions related to generating a web service. User interface 300 is only one example of several possible embodiments for implementing a user interface for a web service generation system. Other user interfaces for generating a web service that differ from user interface 300 are still considered within the scope of the present invention.

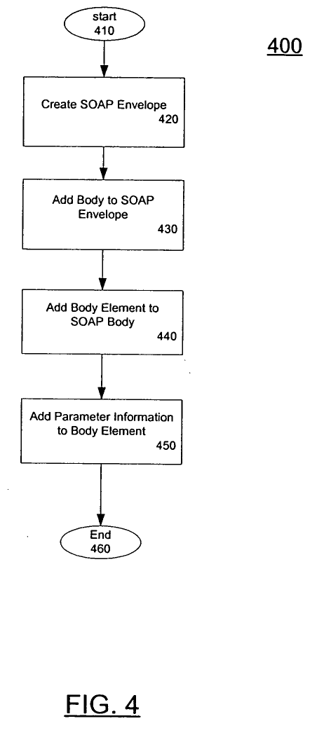

In one embodiment of the present invention, the web service generation system automatically constructs a SOAP envelope for invoking a remote web service. A method 400 for automatically generating a SOAP envelope in accordance with one embodiment of the present invention is shown in FIG. 4. The method begins in start step 410. Then, a SOAP envelope is created in step 420. Next, a body is added to the SOAP envelope in step 430. Then, a SOAP body element is added to the SOAP body in step 440. In one embodiment, the name of the body element will be the name of the method. Next, parameter information is added to the SOAP body element in step 450. In one embodiment, parameters or arguments needed to invoke the desired method are converted to XML before being added to the SOAP body element. For example, a “setAddress” method may take the three parameters name, street, and zip. Once the parameters have been added to the body element, SOAP envelope generation is complete and the process ends in step 460. In one embodiment, a java method signature for the method having parameters of name, street, and zip may look like this: void setAddress (String name, String street, int zip).

An example of a SOAP envelope for the corresponding“setAddress” method is shown below.

```
<env:Envelope ....>
    <env:Body>
        <m:setAddress xmlns:m=“http://myurl” >
            <name>joe</name>
            <street>north first street</street>
            <zip>63844</zip>
        </m:setAddress>
    </env:Body>
</env:Envelope>
```

In one embodiment of the present invention, the web services are implemented as remote procedure call (RPC) web services. An RPC style web service is implemented using a stateless session EJB. The RPC style web service appears as a remote object to the client application. The interaction between a client and an RPC-style web service centers around a service-specific interface. When a client invokes a web service, the client sends parameter values to the web service. The web service then executes the required methods and then transmits the return values back to the client. RPC-style web services are synchronous, in that when a client sends a request, it waits for a response before doing anything else.

The XML encoded parameters for an RPC web service are placed inside a SOAP envelope and sent to the web service as an HTTP post request. In one embodiment, the web service may have a result or output after receiving the post request. In this case, the result of the HTTP post request is received by the client as an HTTP response wrapped in a SOAP envelope. The response SOAP envelope is then parsed to retrieve the response from the web service.

The present invention provides a system for generating web service from multiple remote web services. The remote web services may span heterogenous hardware and software platforms. The web services are each characterized as a java interface and used as normal java object types. In one embodiment of the present invention, web services are accessed using standard web protocols such as XML and HTTP. The application that provides the functionality is packaged as a web service allowing each system to communicate with any other system. In one embodiment of the present invention, the invention is implemented in java using java communication commands and java programming objects.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing at least one of additive model representation and reconstruction.

Included in the programming (software) of the general/specialized computer or microprocessor are software modules for implementing the teachings of the present invention, including, but not limited to, separating planes of a source image, averaging at least one of foreground and background colors, replacing colors, and compensating for error introduced by color replacement in one plane by feeding error into a second plane, storage, communication of results, and reconstructing an image according to the processes of the present invention.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A method for providing a web service gateway, comprising:
receiving a first invoke call for a target web service, the target web service one of a plurality of web services, the first invoke call received from a client on a first platform; and
invoking the target web service with a second invoke call, the second invoke call made to the target on a second platform.

2. (Cancelled)

3. (Cancelled)

4. (Cancelled)

5. (Cancelled)

6. (Cancelled)

7. (Cancelled)

8. (Cancelled)

9. (Cancelled)

10. (Cancelled)

11. (Cancelled)

12. (Cancelled)

13. (Cancelled)

14. (Cancelled)

15. (Cancelled)

16. (Cancelled)

17. (Cancelled)

18. (Cancelled)

19. (Cancelled)

20. (Cancelled)

21. (Cancelled)

22. (Cancelled).

23. (Cancelled)

24. (Cancelled)

25. (Cancelled)

26. (Cancelled)

27. (Cancelled)

28. The method of claim 1 wherein the first platform and the second platform are heterogeneous platforms.

29. The method of claim 1 further comprising:
parsing the invoke call to retrieve parameters, at least a portion of the parameters included in the second invoke call.

30. The method of claim 29 wherein said invoking the one of the plurality of web services includes:
placing the retrieved parameters in an internal data structure; and
generating the second invoke call from the internal data structure.

31. The method of claim 1 wherein the first invoke call is received from a client.

32. The method of claim 1 wherein the first invoke call is received from a requesting web service, the plurality of web services including the requesting web service.

33. The method of claim 32 wherein the requesting web service and target web service transmit and receive information in different formats.

34. The method of claim 32 wherein the requesting web service and target web service are heterogeneous web services.

35. A method for providing a proxy, comprising:
generating a new web service from a first web service description file, the first web service description file associated with a first web service, the new web service having a similar interface as the first web service;
receiving a first invoke call made to a new web service;
retrieving parameters from the first invoke call to the new web service; and
invoking the new web service using the parameters from the first invoke call.

36. The method of claim 35 wherein generating the new web service includes:
parsing the first web service description file that corresponds to a first web service;
introspecting the first web service description file; and
generating a new web service from the introspected parsed web service description file, the new web service having a similar interface as the first web service.
